(19) United States
(12) Patent Application Publication
(10) Pub. No.: US 2023/0192144 A1
(43) Pub. Date: Jun. 22, 2023

(54) UNCERTAINTY PREDICTION FOR A PREDICTED PATH OF AN OBJECT THAT AVOIDS INFEASIBLE PATHS

(71) Applicant: GM Cruise Holdings LLC, San Francisco, CA (US)

(72) Inventors: Chenyi Chen, Belmont, CA (US); Ariel Arturo Perez Chavez, Mountain View, CA (US); Frank Jiang, San Francisco, CA (US); Mircea Grecu, San Mateo, CA (US)

(21) Appl. No.: 17/553,412

(22) Filed: Dec. 16, 2021

(51) Int. Cl. B60W 60/00; B60W 50/02; B60W 50/00; G05B 13/04

(52) U.S. Cl. CPC B60W 60/0027; B60W 50/0205; B60W 50/0225; B60W 50/0097; G05B 13/048; G06V 20/56

(57) ABSTRACT

System, methods, and computer-readable media for training an object path prediction model to reduce an uncertainty of a predicted path when the predicted path of an object adjacent to another object. The training penalizes an uncertainty area prediction associated with a predicted future location of a nearby object to an autonomous vehicle (AV) when the uncertainty area prediction overlaps with another object to which the first detected object would be adjacent at the predicted future location. The training also penalizes a set of predicted future locations that implies improbable vehicle kinematics, whereby the object path prediction model becomes trained to avoid predicting similar sets of predicted future locations with improbable vehicle kinematics.

### TECHNICAL FIELD

The subject technology provides pertains to providing an uncertainty prediction associated with a predicted path of an object, and more specifically, pertains to providing an uncertainty prediction for the predicted path of the object avoids an uncertainty prediction that suggests an infeasible trajectory for the object.

### BACKGROUND

An autonomous vehicle is a motorized vehicle that can navigate without a human driver. An exemplary autonomous vehicle includes a plurality of sensor systems, such as, but not limited to, a camera sensor system, a lidar sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system.

Many autonomous vehicles make decisions based on prediction models that make predictions of paths of surrounding objects. Such prediction models can be improved to deliver a better experience to passengers.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a system for managing one or more Autonomous Vehicles (AVs) in accordance with some aspects of the present technology;

FIGS. 2A and 2B show example environments, in which an autonomous vehicle detects a nearby vehicle, in accordance with some aspects of the present technology;

FIG. 3 shows an example diagram of calculating an uncertainty hull in accordance with some aspects of the present technology;

FIG. 4 shows an example flow diagram of training an object path prediction model in accordance with some aspects of the present technology;

FIG. 5 shows an example flow diagram of predicting a path based on an object path prediction model in accordance with some aspects of the present technology;

FIG. 6 shows an example flow diagram of training an object path prediction model to reduce predicted paths that result in improbable vehicle kinematics in accordance with some aspects of the present technology; and

FIG. 7 shows an example system for implementing certain aspects of the present technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

The disclosed technology addresses the need in the art for an object path prediction model that can provide an improved uncertainty prediction that does not imply an infeasible trajectory for a predicted path of an object—or at least minimizes any implied trajectories that are infeasible.

In particular, some prediction models predict a trajectory of an object and provide an associated uncertainty prediction that reflects an uncertainty about the exact path of the object. The uncertainty prediction is a distribution of probable deviations from the predicted path. However, prior path prediction models sometimes provide uncertainty predictions where some paths suggested by the uncertainty prediction would result in a collision, a vehicle leaving the roadway, or other infeasible paths. Often many of these uncertainty predictions simply occupy too large of an implied movable area and would be improved if they were reduced to be more focused on likely paths. One result of these uncertainty predictions that are too large is that they may cause an autonomous vehicle relying on the uncertainty prediction to brake suddenly to avoid a phantom collision because the uncertainty prediction implies that the collision is probable.

In some embodiments, the present technology includes training a machine-learning algorithm to provide the improved uncertainty prediction to yield the object path prediction model. In some embodiments, the present technology includes a training technique that identifies uncertainty predictions that imply an infeasible trajectory and prunes excessive uncertainties associated with physical boundaries of drivable free space for nearby moving objects (e.g., a vehicle, a pedestrian, etc.).

Therefore, the present technology provides a training technique that penalizes an uncertainty area prediction associated with a predicted future location of a first nearby object to an autonomous vehicle (AV) when the uncertainty area prediction overlaps with a second object to which the first nearby object would be adjacent at the predicted future location.

Additionally, the present technology provides a training technique that further penalizes predicted paths that result in improbable vehicle kinematics, such as improbable turn rates, slip angles, velocities, or accelerations.

The training techniques and object path prediction model for an autonomous vehicle of the present technology solves at least these problems and provides other benefits, as will be apparent from the figures and description provided herein.

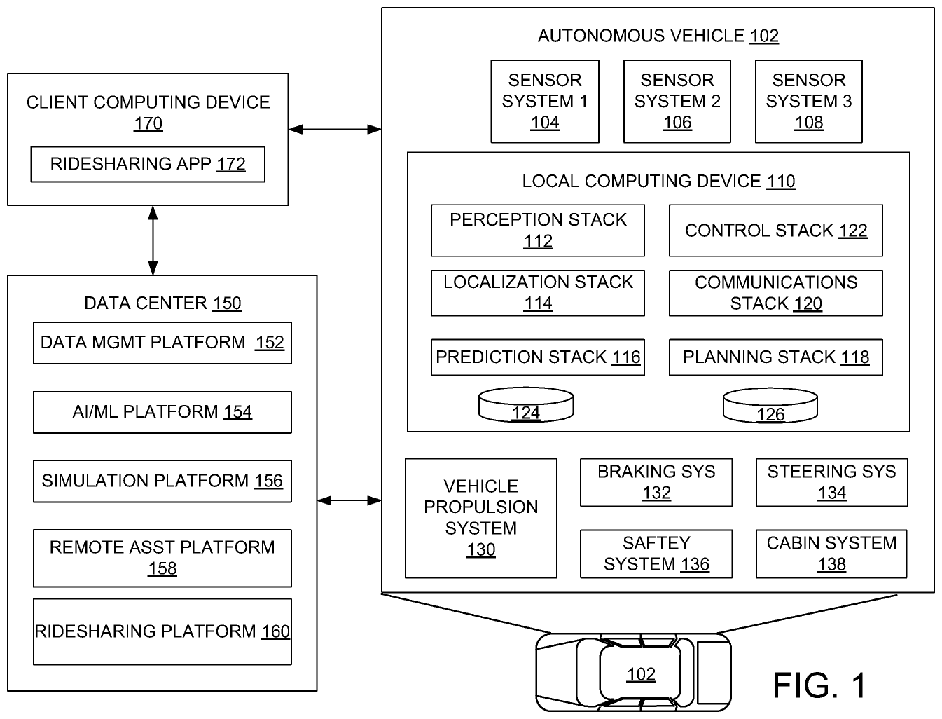

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general-purpose computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

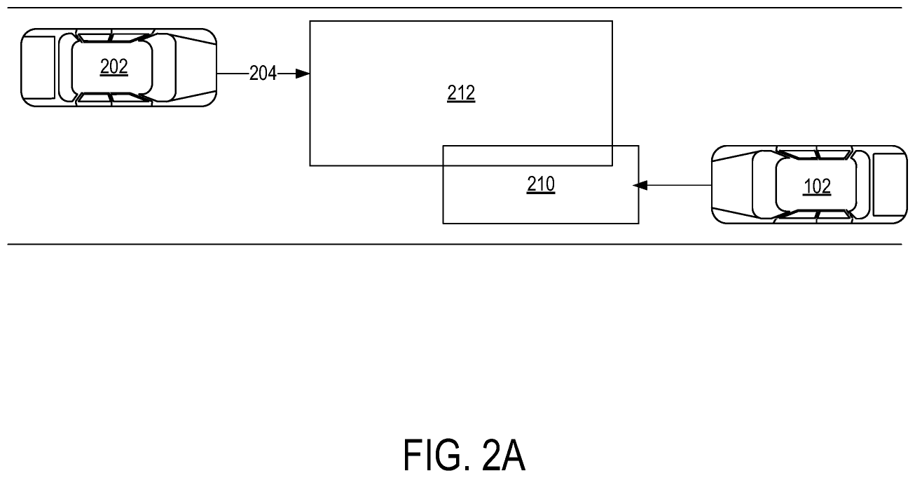

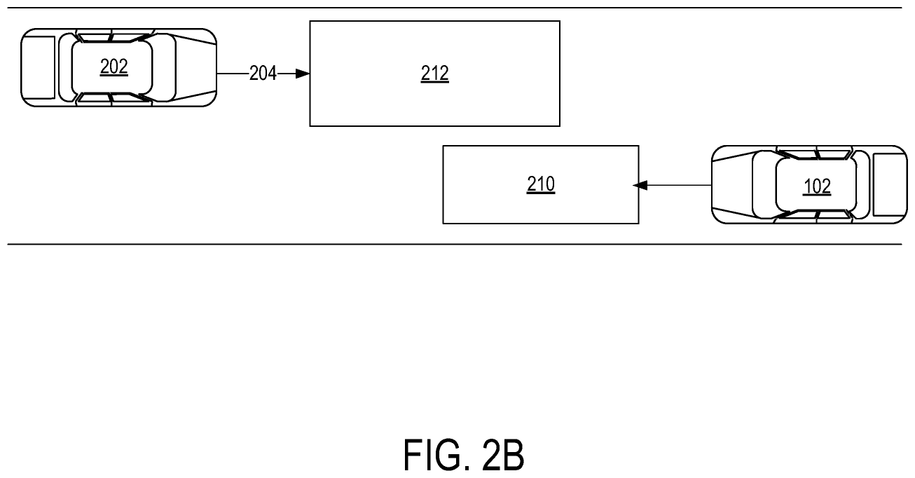

FIGS. 2A and 2B illustrate example environments for the autonomous vehicle, in which a detected object is nearby, in accordance with some aspects of the present technology.

In FIG. 2A, the detected object is a vehicle 202, for which an object path prediction model of the prediction stack 116 would predict a path. More specifically, the vehicle 202 may be an oncoming vehicle from the perspective of the AV 102. In predicting the path, the object path prediction model may first determine a set of possible future paths that the vehicle 202 may take, the probability that the vehicle 202 may take any of the predicted paths, a set of points along each of the predicted paths, and/or a predicted uncertainty associated with each of the points.

The object path prediction model may predict a first path 204 and an uncertainty hull 212. There may be an unnecessarily large lateral uncertainty in one or more of the predicted points along a predicted path, such as the uncertainty hull 212, which may heavily engulf free space ahead of the AV 102. The uncertainty hull 212 represents a probability that vehicle 202 will be anywhere within that area. Since the uncertainty hull 212 is so large, the AV 102 perceives that there is at least a probability of a collision which may cause the planning stack 118 to apply the brake and stop suddenly. Based on the assumption that humans are generally rational and vehicles would not take a trajectory that collides with a nearby object, the object path prediction model may be trained to in effect to prune the uncertainty hull 212 to be smaller such that that it would not overlap with another object in a same future time frame. In this case, the other object is the AV 102, which is determined to take a future space 210 during the same future time frame as the uncertainty hull 212. Alternatively, the overlap may also be with respect to other objects, such as other moving or stationary vehicles.

As such, the object path prediction model may learn to avoid uncertainty predictions that would result in an uncertainty hull 212 that would overlap with another object. Consequently, the trained object path prediction model may provide more refined uncertainty predictions that would not imply a probable collision.

FIG. 2B illustrates the uncertainty hull 212 resulting from more refined uncertainty predictions by the object path prediction model trained to predict paths that do not imply unrealistic collisions. Since the uncertainty hull 212 does not overlap with the path of the AV 102, the AV 102 may proceed forward more naturally.

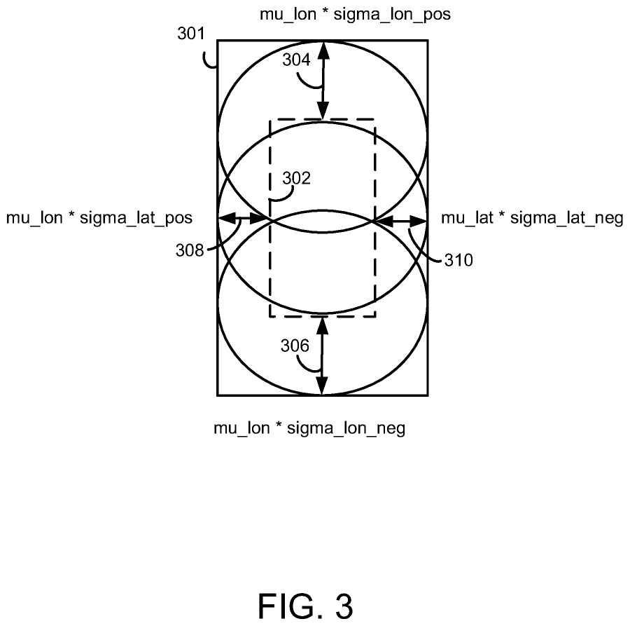

FIG. 3 shows an example diagram that illustrates how an uncertainty hull is determined in accordance with some aspects of the present technology. An uncertainty hull 301 may be built to surround a representation 302 of a detected object (e.g., the vehicle 204) at a future predicted location. The uncertainty hull 301 may be created based on the uncertainty area prediction(s) associated with the detected object. The uncertainty area prediction may be split into a predicted latitudinal uncertainty and a predicted longitudinal uncertainty.

The uncertainty hull 301 may be built based on a frontal latitudinal uncertainty 304 represented by a half-gaussian distribution in the frontal direction, a rear latitudinal uncertainty 306 represented by a half-gaussian distribution in the rear direction, a left longitudinal uncertainty 308 represented by a half-gaussian distribution in the left direction, and a right longitudinal uncertainty 310 represented by a half-gaussian distribution in the right direction. Once the uncertainty hull 301 is built, a plurality of uncertainty ellipses, such as three circles, are drawn. For example, a first circle may be drawn with a center at the front of the representation 302 of the object, a second circle may be drawn at the rear of the representation 302 of the object, and a third circle may be drawn at the center of the representation 302 of the object. The circles may have a diameter equivalent to the width of the uncertainty hull 301.

More specifically, the frontal latitudinal uncertainty 304 may be calculated by mu_lon*sigma_lon_pos, the rear latitudinal uncertainty 306 may be calculated by mu_lon*sigma_lon_neg, the left longitudinal uncertainty 308 may be calculated by mu_lon*sigma_lat_pos, and the right longitudinal uncertainty 310 may be calculated by mu_lat*sigma_lat_neg. Mu may represent a confidence interval of a gaussian distribution, e.g., mu=1 represents 68% confidence interval, while mu=2 represents 95% confidence interval. The mu is decoupled for lateral and longitudinal directions because most of the uncertainty issues are due to lateral uncertainty, so a larger mu may be placed on the lateral uncertainty than on longitudinal uncertainty.

Another set of ellipses may be drawn for another object, whether within another uncertainty hull or another representation of an object. The two sets of ellipses are used to calculate a set of distances between the respective ellipses. For example, three distances between the three circles shown in FIG. 3 and another three circles may be calculated. If any of the distances are equal to or less than the sum of diameters of the two circles being measured, uncertainty hull 301 may be penalized. As such, the distance check is used to surrogate an overlapping calculation between the uncertainty hull and another hull or representation of an object.

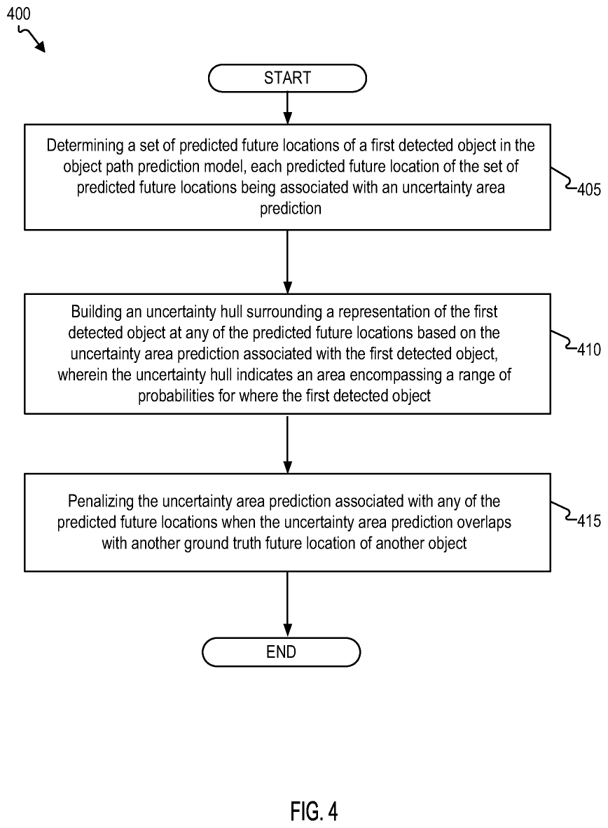

FIG. 4 shows an example method for providing feedback to a machine learning algorithm for training an object path prediction model in accordance with some aspects of the present technology. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

The method depicted in FIG. 4 can be performed by the AI/ML platform 154 in association with the simulation platform 156. For example, the simulation platform 156 can generate a plurality of simulated scenes, including a simulation of AV 102 (and simulations of its associated components) and other objects such as vehicles, pedestrians, etc. The method depicted in FIG. 4 can be carried out as AI/ML platform 154 receives feedback on uncertainty predictions made by the object path prediction model in the simulation environment.

According to some aspects, the method includes determining a set of predicted future locations of a first detected object in the object path prediction model in step 405. Each predicted future location of the set of predicted future locations is associated with an uncertainty area prediction. For example, the simulated object path prediction model may determine a set of predicted future locations of a first detected object. Each predicted future location of the set of predicted future locations is associated with an uncertainty area prediction.

According to some aspects, the method includes building an uncertainty hull surrounding a representation of the first detected object at any of the predicted future locations based on the uncertainty area prediction associated with the first detected object, wherein the uncertainty hull indicates an area encompassing a range of probabilities for where the first detected object could be at step 410. For example, the AI/ML platform 154 illustrated in FIG. 1 may build the uncertainty hull surrounding a representation of the first detected object at any of the predicted future locations based on the uncertainty area prediction associated with the first detected object. The following paragraphs provide more detail on the uncertainty predictions and how they determine the uncertainty hull.

In some aspects, the predicted uncertainty area is based on a predicted latitudinal uncertainty and a predicted longitudinal uncertainty around a point on a predicted trajectory. The predicted longitudinal uncertainty can comprise the frontal latitudinal uncertainty 304 represented by a half-gaussian distribution in a frontal direction and the rear latitudinal uncertainty 306 represented by a half-gaussian distribution in a rear direction, the left longitudinal uncertainty 308 represented by a half-gaussian distribution in a left direction, and the right longitudinal uncertainty 310 represented by a half-gaussian distribution in a right direction.

The AI/ML platform 154 can form a plurality of uncertainty ellipses within the uncertainty hull 301. The uncertainty ellipses may be used to calculate a set of distances between each of the uncertainty ellipses and each of a corresponding uncertainty ellipse of another set of uncertainty ellipses. Since drivers usually try to avoid collisions, it can be concluded that the uncertainty prediction is larger than what will be observed in the real world. As such, the AI/ML platform 154 can penalize the predicted uncertainty area when any of the distances are equal to or less than a sum of diameters of two uncertainty ellipses being measured

In some aspects, the first detected object is represented by a bounding box indicating a physical area predicted to be occupied by the first detected object. As such, the uncertainty hull is a larger box indicating an area encompassing a range of probable error around a point on a predicted path in which the first detected object could be.

According to some aspects, the method includes determining that the uncertainty area prediction overlaps with one of the predicted future locations of another object. For example, the AI/ML platform 154 illustrated in FIG. 1 may determine that the uncertainty area prediction overlaps with one of the predicted future locations of another object.

According to some aspects, the method includes penalizing the uncertainty area prediction associated with any of the predicted future locations when the uncertainty area prediction overlaps with another ground truth future location of another object at step 415. For example, the AI/ML platform 154 illustrated in FIG. 1 may penalize the uncertainty area prediction associated with any of the predicted future locations when the uncertainty area prediction overlaps with another ground truth future location of another object. In some aspects, the penalizing includes utilizing a loss function to provide feedback to improve the object path prediction model.

In some aspects, the another object for which the uncertainty area prediction overlaps can be the AV 102, on which the object path prediction model is configured to execute.

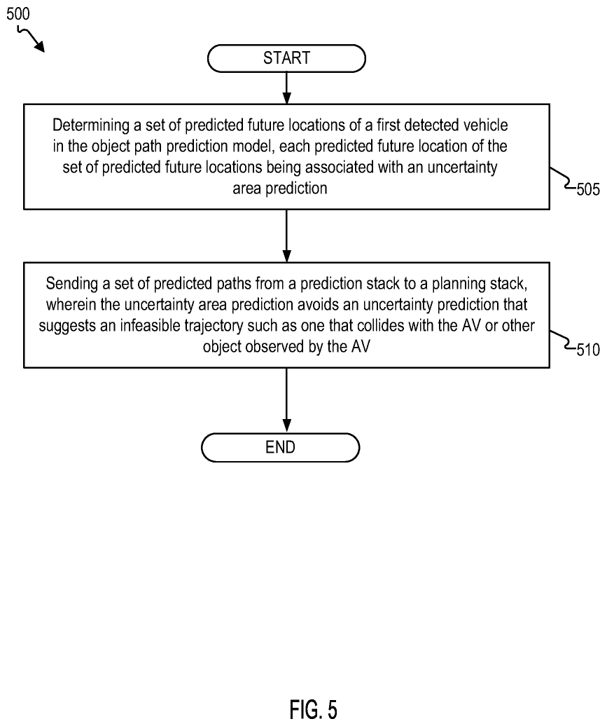

FIG. 5 shows an example flow diagram of predicting a path based on an object path prediction model in accordance with some aspects of the present technology. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence. While the method illustrated in FIG. 5 will be explained as if it were being performed by AV 102, the method could also be performed using simulation platform 156.

According to some aspects, the method includes determining a set of predicted future locations of a first detected object in the object path prediction model, each predicted future location of the set of predicted future locations being associated with an uncertainty area prediction at step 505. For example, the prediction stack 116 illustrated in FIG. 1 may determine a set of predicted future locations of a first detected object in the object path prediction model, each predicted future location of the set of predicted future locations is associated with an uncertainty area prediction.

The prediction stack 116 can include the trained object path prediction model as explained with respect to FIG. 4. Accordingly, prediction stack 116, including the trained object path prediction model, is configured to output uncertainty predictions that do not overlap with other observed objects or the future path of the AV 102.

According to some aspects, the method includes sending a set of predicted paths from a prediction stack to a planning stack at step 515, wherein the uncertainty area prediction avoids an uncertainty prediction that suggests an infeasible trajectory, such as one that collides with the AV 102 or another object observed by the AV 102. For example, the prediction stack 116 illustrated in FIG. 1 may send the set of predicted paths to the planning stack 118. The planning stack 118 can consume the path prediction and uncertainty predictions from prediction stack 116 to plan a trajectory for the AV 102 to pilot itself along a route.

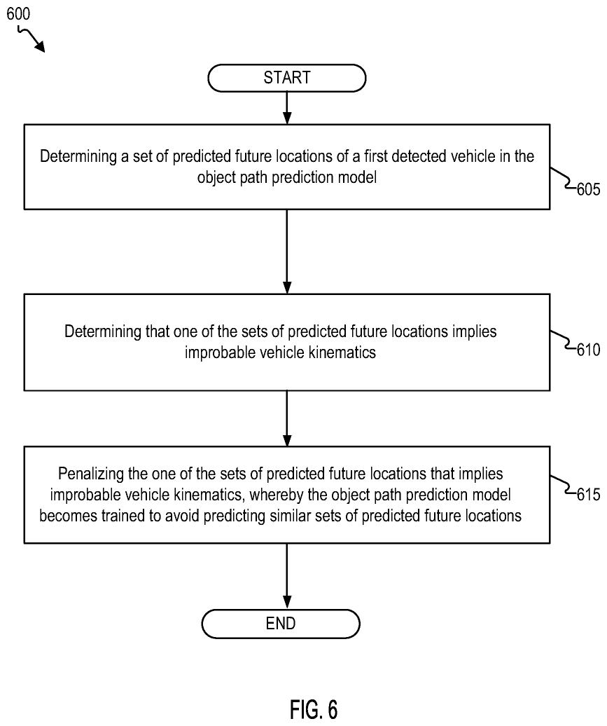

FIG. 6 shows an example flow diagram of training an object path prediction model to reduce predicted paths that result in improbable vehicle kinematics in accordance with some aspects of the present technology. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some aspects, the method includes determining a set of predicted future locations of a first detected object in the object path prediction model at step 605. For example, the AI/ML platform 154 illustrated in FIG. 1 may determine a set of predicted future locations of a first detected object in the object path prediction model.

According to some aspects, the method includes determining that one of the sets of predicted future locations implies improbable vehicle kinematics at step 610. For example, the AI/ML platform 154 illustrated in FIG. 1 may that one of the sets of predicted future locations implies improbable vehicle kinematics.

According to some aspects, the method includes penalizing the one of the sets of predicted future locations that implies improbable vehicle kinematics at step 615. For example, the AI/ML platform 154 illustrated in FIG. 1 may penalize the one of the sets of predicted future locations that implies improbable vehicle kinematics, whereby the object path prediction model becomes trained to avoid predicting similar sets of predicted future locations.

According to some aspects, the method includes determining that the one of the sets of predicted future locations implies improbable vehicle kinematics when a turn rate between predicted future locations is greater than a set degree for every set increment of time. For example, the prediction stack 116 illustrated in FIG. 1 may determine that the one of the sets of predicted future locations implies improbable vehicle kinematics when a turn rate between predicted future locations is greater than a set degree for every set increment of time. In some aspects, the turn rate may be above 0.40.

According to some aspects, the method includes determining that the one of the sets of predicted future locations implies improbable vehicle kinematics when a slip angle between predicted future locations is greater than a set degree. For example, the prediction stack 116 illustrated in FIG. 1 may determine that the one of the sets of predicted future locations implies improbable vehicle kinematics when a slip angle between predicted future locations is greater than a set degree. In some aspects, the slip angle is an angle between a velocity vector of the first detected object and a yaw of the first detected object. In some aspects, the slip angle may be above 0.40.

According to some aspects, the method includes determining that the one of the sets of predicted future locations implies improbable vehicle kinematics by calculating velocity values and acceleration values between predicted future locations and determining that one of the calculated velocity values or acceleration values is outside of an acceptable range of velocity values or acceleration values. For example, the prediction stack 116 illustrated in FIG. 1 may determine that the one of the sets of predicted future locations implies improbable vehicle kinematics by calculating velocity values and acceleration values between predicted future locations and determining that one of the calculated velocity values or acceleration values is outside of an acceptable range of velocity values or acceleration values. The velocity values may be derived from the predicted future locations over a known period of time and the acceleration values may be derived from the derived velocity values over a known period of time.

According to some aspects, the method includes determining that one of the calculated velocity values or acceleration values is outside of an acceptable range of velocity values or acceleration values. For example, the prediction stack 116 illustrated in FIG. 1 may determine that one of the calculated velocity values or acceleration values is outside of an acceptable range of velocity values or acceleration values.

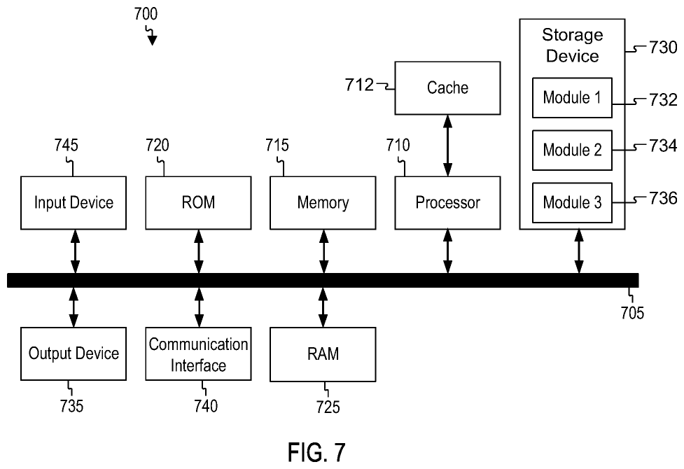

FIG. 7 shows an example of computing system 700, which can be for example any computing device making up an autonomous vehicle 102 and/or a data center 150, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A computer-implemented method for training an object path prediction model to reduce an uncertainty of a predicted path when the predicted path of an object adjacent to another object, the method comprising: determining a set of predicted future locations of a first detected object in the object path prediction model, each predicted future location of the set of predicted future locations being associated with an uncertainty area prediction; and penalizing the uncertainty area prediction associated with any of the predicted future locations when the uncertainty area prediction overlaps with another ground truth future location of another object.

Aspect 2: The computer-implemented method of Aspect 1, wherein the penalizing includes utilizing a loss function to provide feedback to the object path prediction model to improve itself.

Aspect 3: The computer-implemented method of any of Aspects 1 to 2, the method comprising: determining that any of the predicted future locations when the uncertainty area prediction overlaps with the another object prior to the penalizing of the uncertainty area prediction.

Aspect 4: The computer-implemented method of any of Aspects 1 to 3, further comprising: building an uncertainty hull representing the predicted uncertainty area, wherein the uncertainty hull surrounds a representation of the first detected object at any of the predicted future locations based on the uncertainty area prediction associated with the first detected object.

Aspect 5: The computer-implemented method of any of Aspects 1 to 4, wherein the predicted uncertainty area is calculated based on a predicted latitudinal uncertainty and a predicted longitudinal uncertainty.

Aspect 6: The computer-implemented method of any of Aspects 1 to 5, wherein the building the uncertainty hull further comprises: calculating a frontal latitudinal uncertainty represented by a half-gaussian distribution in a frontal direction; calculating a rear latitudinal uncertainty represented by a half-gaussian distribution in a rear direction; calculating a left longitudinal uncertainty represented by a half-gaussian distribution in a left direction; and calculating a right longitudinal uncertainty represented by a half-gaussian distribution in a right direction.

Aspect 7: The computer-implemented method of any of Aspects 1 to 6, further comprising: forming a set of uncertainty ellipses in the uncertainty hull; calculating a set of distances between each of the uncertainty ellipses and each of a corresponding uncertainty ellipse of another set of uncertainty ellipses, wherein the another set of uncertainty ellipses represent another object; and penalizing the predicted uncertainty area when any of the distances are equal to or less than a sum of diameters of two uncertainty ellipses being measured.

Aspect 8: The computer-implemented method of any of Aspects 1 to 7, wherein the first detected object is represented by a bounding box indicating a physical area predicted to be occupied by the first detected object, and the uncertainty hull is a larger box indicating an area encompassing a range of probable error in which the first detected object could be.

Aspect 9: The computer-implemented method of any of Aspects 1 to 8, wherein the another object is an autonomous vehicle (AV) on which the object path prediction model is configured to execute.

Aspect 10: The computer-implemented method of any of Aspects 1 to 9, further comprising: inputting a planned path for the AV into the object path prediction model, whereby the penalizing of the uncertainty area prediction associated with any of the predicted future locations occurs when the uncertainty area prediction associated with any of the predicted future locations overlaps with the AV on its future ground truth path.

Aspect 11: A computer-implemented method for training an object path prediction model to reduce predicted paths that result in improbable vehicle kinematics, the method comprising: determining a set of predicted future locations of a first detected object in the object path prediction model; determining that one of the sets of predicted future locations implies improbable vehicle kinematics; and penalizing the one of the sets of predicted future locations that implies the improbable vehicle kinematics, whereby the object path prediction model becomes trained to avoid predicting similar sets of predicted future locations.

Aspect 12: The computer-implemented method of Aspect 11, further comprising: determining that the one of the sets of predicted future locations implies the improbable vehicle kinematics when a turn rate between predicted future locations is greater than a set degree for every set increment of time.

Aspect 13: The computer-implemented method of any of Aspects 11 to 12, further comprising: determining that the one of the sets of predicted future locations implies the improbable vehicle kinematics when a slip angle between predicted future locations is greater than a set degree, wherein the slip angle is an angle between a velocity vector of the first detected object and a yaw of the first detected object.

Aspect 14: The computer-implemented method of any of Aspects 11 to 13, further comprising: determining that the one of the sets of predicted future locations implies the improbable vehicle kinematics by: calculating velocity values and acceleration values between predicted future locations; and determining that one of the calculated velocity values or acceleration values is outside of an acceptable range of velocity values or acceleration values.

Aspect 15: A non-transitory computer-readable medium comprising instructions, the instructions, when executed by a computing system, cause the computing system to: determine a set of predicted future locations of a first detected object in an object path prediction model, each predicted future location of the set of predicted future locations be associated with an uncertainty area prediction; and penalize the uncertainty area prediction associated with any of the predicted future locations when the uncertainty area prediction overlaps with another ground truth future location of another object.

Aspect 16: The non-transitory computer-readable medium of Aspect 15, wherein the penalizing includes utilizing a loss function to provide feedback to the object path prediction model to improve itself

Aspect 17: The non-transitory computer-readable medium of any of Aspects 15 to 16, wherein the non-transitory computer-readable medium further comprises instructions that, when executed by the computing system, cause the computing system to: determine that any of the predicted future locations when the uncertainty area prediction overlaps with the another object prior to penalizing the uncertainty area prediction.

Aspect 18: The non-transitory computer-readable medium of any of Aspects 15 to 17, wherein the non-transitory computer-readable medium further comprises instructions that, when executed by the computing system, cause the computing system to: build an uncertainty hull representing the predicted uncertainty area, wherein the uncertainty hull surrounds a representation of the first detected object at any of the predicted future locations based on the uncertainty area prediction associated with the first detected object.

Aspect 19: The non-transitory computer-readable medium of any of Aspects 15 to 18, wherein the building the uncertainty hull further comprises: calculating a frontal latitudinal uncertainty represented by a half-gaussian distribution in a frontal direction; calculating a rear latitudinal uncertainty represented by a half-gaussian distribution in a rear direction; calculating a left longitudinal uncertainty represented by a half-gaussian distribution in a left direction; and calculating a right longitudinal uncertainty represented by a half-gaussian distribution in a right direction.

Aspect 20: A system for training an object path prediction model to reduce an uncertainty of a predicted path when the predicted path of an object adjacent to another object, comprising: a storage configured to store instructions; and one or more processors configured to execute the instructions and cause the one or more processors to: determine a set of predicted future locations of a first detected object in the object path prediction model, each predicted future location of the set of predicted future locations be associated with an uncertainty area prediction; and penalize the uncertainty area prediction associated with any of the predicted future locations when the uncertainty area prediction overlaps with another ground truth future location of another object.

Aspect 21: A non-transitory computer-readable medium comprising instructions, the instructions, when executed by a computing system, cause the computing system to: determine a set of predicted future locations of a first detected object in the object path prediction model, each predicted future location of the set of predicted future locations be associated with an uncertainty area prediction; and penalize the uncertainty area prediction associated with any of the predicted future locations when the uncertainty area prediction overlaps with another ground truth future location of another object.

Aspect 22: The computer-readable medium of Aspect 21, the penalizing includes utilizing a loss function to provide feedback to the object path prediction model to improve itself

Aspect 23: The computer-readable medium of any of Aspects 21 to 22, wherein the computer-readable medium further comprises instructions that, when executed by the computing system, cause the computing system to: determine that any of the predicted future locations when the uncertainty area prediction overlaps with the another object prior to the penalizing of the uncertainty area prediction.

Aspect 24: The computer-readable medium of any of Aspects 21 to 23, wherein the computer-readable medium further comprises instructions that, when executed by the computing system, cause the computing system to: build an uncertainty hull representing the predicted uncertainty area, wherein the uncertainty hull surrounds a representation of the first detected object at any of the predicted future locations based on the uncertainty area prediction associated with the first detected object.

Aspect 25: The computer-readable medium of any of Aspects 21 to 24, the predicted uncertainty area is calculated based on a predicted latitudinal uncertainty and a predicted longitudinal uncertainty.

Aspect 26: The computer-readable medium of any of Aspects 21 to 25, wherein the computer-readable medium further comprises instructions that, when executed by the computing system, cause the computing system to: calculate a frontal latitudinal uncertainty represented by a half-gaussian distribution in a frontal direction; calculate a rear latitudinal uncertainty represented by a half-gaussian distribution in a rear direction; calculate a left longitudinal uncertainty represented by a half-gaussian distribution in a left direction; and calculate a right longitudinal uncertainty represented by a half-gaussian distribution in a right direction.

Aspect 27: The computer-readable medium of any of Aspects 21 to 26, wherein the computer-readable medium further comprises instructions that, when executed by the computing system, cause the computing system to: form a set of uncertainty ellipses in the uncertainty hull; calculate a set of distances between each of the uncertainty ellipses and each of a corresponding uncertainty ellipse of another set of uncertainty ellipses, wherein the another set of uncertainty ellipses represent another object; and penalize the predicted uncertainty area when any of the distances are equal to or less than a sum of diameters of two uncertainty ellipses be measured.

Aspect 28: The computer-readable medium of any of Aspects 21 to 27, the first detected object is represented by a bounding box indicating a physical area predicted to be occupied by the first detected object, and the uncertainty hull is a larger box indicating an area encompassing a range of probable error in which the first detected object could be.

Aspect 29: The computer-readable medium of any of Aspects 21 to 28, the another object is an autonomous vehicle (AV) on which the object path prediction model is configured to execute.

Aspect 30: The computer-readable medium of any of Aspects 21 to 29, wherein the computer-readable medium further comprises instructions that, when executed by the computing system, cause the computing system to: input a planned path for the AV into the object path prediction model, whereby the penalizing of the uncertainty area prediction associated with any of the predicted future locations occurs when the uncertainty area prediction associated with any of the predicted future locations overlaps with the AV on its future ground truth path.

Aspect 31: A system comprising: a storage configured to store instructions; a processor configured to execute the instructions and cause the processor to: determine a set of predicted future locations of a first detected object in the object path prediction model, each predicted future location of the set of predicted future locations be associated with an uncertainty area prediction, and penalize the uncertainty area prediction associated with any of the predicted future locations when the uncertainty area prediction overlaps with another ground truth future location of another object.

Aspect 32: The system of Aspect 31, wherein the penalizing includes utilizing a loss function to provide feedback to the object path prediction model to improve itself

Aspect 33: The system of any of Aspects 31 to 32, wherein the processor is configured to execute the instructions and cause the processor to: determine that any of the predicted future locations when the uncertainty area prediction overlaps with the another object prior to the penalizing of the uncertainty area prediction.

Aspect 34: The system of any of Aspects 31 to 33, wherein the processor is configured to execute the instructions and cause the processor to: build an uncertainty hull representing the predicted uncertainty area, wherein the uncertainty hull surrounds a representation of the first detected object at any of the predicted future locations based on the uncertainty area prediction associated with the first detected object.

Aspect 35: The system of any of Aspects 31 to 34, wherein the predicted uncertainty area is calculated based on a predicted latitudinal uncertainty and a predicted longitudinal uncertainty.

Aspect 36: The system of any of Aspects 31 to 35, wherein the processor is configured to execute the instructions and cause the processor to: calculate a frontal latitudinal uncertainty represented by a half-gaussian distribution in a frontal direction; calculate a rear latitudinal uncertainty represented by a half-gaussian distribution in a rear direction; calculate a left longitudinal uncertainty represented by a half-gaussian distribution in a left direction; and calculate a right longitudinal uncertainty represented by a half-gaussian distribution in a right direction.

Aspect 37: The system of any of Aspects 31 to 36, wherein the processor is configured to execute the instructions and cause the processor to: form a set of uncertainty ellipses in the uncertainty hull; calculate a set of distances between each of the uncertainty ellipses and each of a corresponding uncertainty ellipse of another set of uncertainty ellipses, wherein the another set of uncertainty ellipses represent another object; and penalize the predicted uncertainty area when any of the distances are equal to or less than a sum of diameters of two uncertainty ellipses be measured.

Aspect 38: The system of any of Aspects 31 to 37, wherein the first detected object is represented by a bounding box indicating a physical area predicted to be occupied by the first detected object, and the uncertainty hull is a larger box indicating an area encompassing a range of probable error in which the first detected object could be.

Aspect 39: The system of any of Aspects 31 to 38, wherein the another object is an autonomous vehicle (AV) on which the object path prediction model is configured to execute.

Aspect 40: The system of any of Aspects 31 to 39, wherein the processor is configured to execute the instructions and cause the processor to: input a planned path for the AV into the object path prediction model, whereby the penalizing of the uncertainty area prediction associated with any of the predicted future locations occurs when the uncertainty area prediction associated with any of the predicted future locations overlaps with the AV on its future ground truth path.

Aspect 41: A computer-implemented method for training an object path prediction model to reduce predicted paths that result in improbable vehicle kinematics, the method comprising: determining a set of predicted future locations of a first detected object in the object path prediction model; determining that one of the sets of predicted future locations implies improbable vehicle kinematics; and penalizing the one of the sets of predicted future locations that implies the improbable vehicle kinematics, whereby the object path prediction model becomes trained to avoid predicting similar sets of predicted future locations.

Aspect 42: The computer-implemented method of Aspect 41, further comprising: determining that the one of the sets of predicted future locations implies the improbable vehicle kinematics when a turn rate between predicted future locations is greater than a set degree for every set increment of time.

Aspect 43: The computer-implemented method of any of Aspects 41 to 42, further comprising: determining that the one of the sets of predicted future locations implies the improbable vehicle kinematics when a slip angle between predicted future locations is greater than a set degree, wherein the slip angle is an angle between a velocity vector of the first detected object and a yaw of the first detected object.

Aspect 44: The computer-implemented method of any of Aspects 41 to 43, further comprising: determining that the one of the sets of predicted future locations implies the improbable vehicle kinematics by: calculating velocity values and acceleration values between predicted future locations; and determining that one of the calculated velocity values or acceleration values is outside of an acceptable range of velocity values or acceleration values.

Aspect 45: A non-transitory computer-readable medium comprising instructions, the instructions, when executed by a computing system, cause the computing system to: determine a set of predicted future locations of a first detected object in the object path prediction model, each predicted future location of the set of predicted future locations be associated with an uncertainty area prediction; and penalize the uncertainty area prediction associated with any of the predicted future locations when the uncertainty area prediction overlaps with another ground truth future location of another object.

Aspect 46: The computer-readable medium of Aspect 45, the penalizing includes utilizing a loss function to provide feedback to the object path prediction model to improve itself

Aspect 47: The computer-readable medium of any of Aspects 45 to 46, wherein the computer-readable medium further comprises instructions that, when executed by the computing system, cause the computing system to: determine that any of the predicted future locations when the uncertainty area prediction overlaps with the another object prior to the penalizing of the uncertainty area prediction.

Aspect 48: The computer-readable medium of any of Aspects 45 to 47, wherein the computer-readable medium further comprises instructions that, when executed by the computing system, cause the computing system to: build an uncertainty hull representing the predicted uncertainty area, wherein the uncertainty hull surrounds a representation of the first detected object at any of the predicted future locations based on the uncertainty area prediction associated with the first detected object.

Aspect 49: The computer-readable medium of any of Aspects 45 to 48, the predicted uncertainty area is calculated based on a predicted latitudinal uncertainty and a predicted longitudinal uncertainty.

Aspect 50: The computer-readable medium of any of Aspects 45 to 49, wherein the computer-readable medium further comprises instructions that, when executed by the computing system, cause the computing system to: calculate a frontal latitudinal uncertainty represented by a half-gaussian distribution in a frontal direction; calculate a rear latitudinal uncertainty represented by a half-gaussian distribution in a rear direction; calculate a left longitudinal uncertainty represented by a half-gaussian distribution in a left direction; and calculate a right longitudinal uncertainty represented by a half-gaussian distribution in a right direction.

Aspect 51: The computer-readable medium of any of Aspects 45 to 50, wherein the computer-readable medium further comprises instructions that, when executed by the computing system, cause the computing system to: form a set of uncertainty ellipses in the uncertainty hull; calculate a set of distances between each of the uncertainty ellipses and each of a corresponding uncertainty ellipse of another set of uncertainty ellipses, wherein the another set of uncertainty ellipses represent another object; and penalize the predicted uncertainty area when any of the distances are equal to or less than a sum of diameters of two uncertainty ellipses be measured.

Aspect 52: The computer-readable medium of any of Aspects 45 to 51, the first detected object is represented by a bounding box indicating a physical area predicted to be occupied by the first detected object, and the uncertainty hull is a larger box indicating an area encompassing a range of probable error in which the first detected object could be.

Aspect 53: The computer-readable medium of any of Aspects 45 to 52, the another object is an autonomous vehicle (AV) on which the object path prediction model is configured to execute.

Aspect 54: The computer-readable medium of any of Aspects 45 to 53, wherein the computer-readable medium further comprises instructions that, when executed by the computing system, cause the computing system to: input a planned path for the AV into the object path prediction model, whereby the penalizing of the uncertainty area prediction associated with any of the predicted future locations occurs when the uncertainty area prediction associated with any of the predicted future locations overlaps with the AV on its future ground truth path.

What is claimed is:

1. A computer-implemented method for training an object path prediction model to reduce an uncertainty of a predicted path when the predicted path of an object adjacent to another object, the method comprising:
determining a set of predicted future locations of a first detected object in the object path prediction model, each predicted future location of the set of predicted future locations being associated with an uncertainty area prediction; and
penalizing the uncertainty area prediction associated with any of the predicted future locations when the uncertainty area prediction overlaps with another ground truth future location of another object.

2. The computer-implemented method of claim 1, wherein the penalizing includes utilizing a loss function to provide feedback to the object path prediction model to improve itself

3. The computer-implemented method of claim 1, the method comprising:
determining that any of the predicted future locations when the uncertainty area prediction overlaps with the another object prior to the penalizing of the uncertainty area prediction.

4. The computer-implemented method of claim 1, further comprising:
building an uncertainty hull representing the predicted uncertainty area, wherein the uncertainty hull surrounds a representation of the first detected object at any of the predicted future locations based on the uncertainty area prediction associated with the first detected object.

5. The computer-implemented method of claim 4, wherein the predicted uncertainty area is calculated based on a predicted latitudinal uncertainty and a predicted longitudinal uncertainty.

6. The computer-implemented method of claim 5, wherein the building the uncertainty hull further comprises:
calculating a frontal latitudinal uncertainty represented by a half-gaussian distribution in a frontal direction;
calculating a rear latitudinal uncertainty represented by a half-gaussian distribution in a rear direction;
calculating a left longitudinal uncertainty represented by a half-gaussian distribution in a left direction; and
calculating a right longitudinal uncertainty represented by a half-gaussian distribution in a right direction.

7. The computer-implemented method of claim 6, further comprising:
forming a set of uncertainty ellipses in the uncertainty hull;
calculating a set of distances between each of the uncertainty ellipses and each of a corresponding uncertainty ellipse of another set of uncertainty ellipses, wherein the another set of uncertainty ellipses represent another object; and
penalizing the predicted uncertainty area when any of the distances are equal to or less than a sum of diameters of two uncertainty ellipses being measured.

8. The computer-implemented method of claim 4, wherein the first detected object is represented by a bounding box indicating a physical area predicted to be occupied by the first detected object, and the uncertainty hull is a larger box indicating an area encompassing a range of probable error in which the first detected object could be.

9. The computer-implemented method of claim 1, wherein the another object is an autonomous vehicle (AV) on which the object path prediction model is configured to execute.

10. The computer-implemented method of claim 9, further comprising:
inputting a planned path for the AV into the object path prediction model, whereby the penalizing of the uncertainty area prediction associated with any of the predicted future locations occurs when the uncertainty area prediction associated with any of the predicted future locations overlaps with the AV on its future ground truth path.

11. A computer-implemented method for training an object path prediction model to reduce predicted paths that result in improbable vehicle kinematics, the method comprising:
determining a set of predicted future locations of a first detected object in the object path prediction model;
determining that one of the sets of predicted future locations implies improbable vehicle kinematics; and
penalizing the one of the sets of predicted future locations that implies the improbable vehicle kinematics, whereby the object path prediction model becomes trained to avoid predicting similar sets of predicted future locations.

12. The computer-implemented method of claim 11, further comprising:
determining that the one of the sets of predicted future locations implies the improbable vehicle kinematics when a turn rate between predicted future locations is greater than a set degree for every set increment of time.

13. The computer-implemented method of claim 11, further comprising:
determining that the one of the sets of predicted future locations implies the improbable vehicle kinematics when a slip angle between predicted future locations is greater than a set degree, wherein the slip angle is an angle between a velocity vector of the first detected object and a yaw of the first detected object.

14. The computer-implemented method of claim 11, further comprising:
determining that the one of the sets of predicted future locations implies the improbable vehicle kinematics by:
calculating velocity values and acceleration values between predicted future locations; and
determining that one of the calculated velocity values or acceleration values is outside of an acceptable range of velocity values or acceleration values.

15. A non-transitory computer-readable medium comprising instructions, the instructions, when executed by a computing system, cause the computing system to:
determine a set of predicted future locations of a first detected object in an object path prediction model, each predicted future location of the set of predicted future locations be associated with an uncertainty area prediction; and
penalize the uncertainty area prediction associated with any of the predicted future locations when the uncertainty area prediction overlaps with another ground truth future location of another object.

16. The non-transitory computer-readable medium of claim 15, wherein the penalizing includes utilizing a loss function to provide feedback to the object path prediction model to improve itself

17. The non-transitory computer-readable medium of claim 15, wherein the non-transitory computer-readable medium further comprises instructions that, when executed by the computing system, cause the computing system to:
determine that any of the predicted future locations when the uncertainty area prediction overlaps with the another object prior to penalizing the uncertainty area prediction.

18. The non-transitory computer-readable medium of claim 17, wherein the non-transitory computer-readable medium further comprises instructions that, when executed by the computing system, cause the computing system to:
build an uncertainty hull representing the predicted uncertainty area, wherein the uncertainty hull surrounds a representation of the first detected object at any of the predicted future locations based on the uncertainty area prediction associated with the first detected object.

19. The non-transitory computer-readable medium of claim 18, wherein the building the uncertainty hull further comprises:
calculating a frontal latitudinal uncertainty represented by a half-gaussian distribution in a frontal direction;
calculating a rear latitudinal uncertainty represented by a half-gaussian distribution in a rear direction;
calculating a left longitudinal uncertainty represented by a half-gaussian distribution in a left direction; and
calculating a right longitudinal uncertainty represented by a half-gaussian distribution in a right direction.

20. The non-transitory computer readable medium of claim 19, wherein the non-transitory computer readable medium further comprises instructions that, when executed by the computing system, cause the computing system to:
form a set of uncertainty ellipses in the uncertainty hull;
calculate a set of distances between each of the uncertainty ellipses and each of a corresponding uncertainty ellipse of another set of uncertainty ellipses, wherein the another set of uncertainty ellipses represent another object; and
penalize the predicted uncertainty area when any of the distances are equal to or less than a sum of diameters of two uncertainty ellipses being measured.
